(19) United States
(12) Patent Application Publication
(10) Pub. No.: US 2010/0298118 A1
(43) Pub. Date: Nov. 25, 2010

(54) FLUID CATALYTIC CRACKING CATALYST WITH LOW COKE YIELD AND METHOD FOR MAKING THE SAME

(76) Inventor: Zhiping Tan, Las Vegas, NV (US)

Correspondence Address: GREER, BURNS & CRAIN, 300 S WACKER DR, 25TH FLOOR, CHICAGO, IL, 60606, US

(21) Appl. No.: 12/470,041

(22) Filed: May 21, 2009

(51) Int. Cl. B01J 29/06

(52) U.S. Cl. 502/68

(57) ABSTRACT

A method is provided for making a fluid catalytic cracking catalyst with a low coke yield from kaolin, including: dividing kaolin into two portions, mixing one portion of kaolin with chemical water and a dispersant to make a slurry, and spraying the slurry to produce kaolin microspheres, calcining the kaolin microspheres at a high temperature to obtain spinel-containing calcined microspheres; calcining the other portion of kaolin to form metakaolin, which is subjected to ultrafine pulverization to obtain metakaolin ultrafine powder; mixing the calcined microspheres with the metakaolin ultrafine powder in a certain proportion, subjecting the resultant mixture to in-situ crystallization on the hydrothermal condition and then to centrifugal separation to obtain an in-situ crystallized product containing zeolite NaY with a high Si/Al ratio; and subjecting the in-situ crystallized product to ion exchange and deep ultrastable hydrothermal treatment to obtain an in-situ crystallized fluid catalytic cracking catalyst.

### FIELD OF THE INVENTION

The invention relates to a fluid catalytic cracking (FCC) catalyst with a low coke yield and a method for making the same, more particularly, to a catalytic cracking catalyst with a reduced coke yield made from kaolin by in-situ crystallization.

### BACKGROUND OF THE INVENTION

Because of the gradual increase of the use of heavy crude oil throughout the world, refineries are increasingly called on to convert heavy residual oil into light, expensive products. Fluid catalytic cracking (FCC) is one of the most efficient and the most economical methods for modifying heavy raw materials, so that the proportion of residual oil blended into feedstock of FCC units rises increasingly.

In a catalytic cracking process, as the feedstock becomes heavy, its carbon residue value rises and coke is thus formed during the reaction. As the catalytic cracking feedstock becomes heavy, the content of polycyclic aromatic hydrocarbons therein also increases and coke is finally formed. For a catalytic cracking reaction, diffusion is a controlling process for limiting the reaction, and the results of research by the China University of Petroleum showed that the molecular size of typical heavy oil ranged from 1 to 2 nm and only when molecules of heavy oil were transported through pores of more than 30 nm, could they be free of restriction of diffusion. Thus, these results emphatically support the necessity of the existence of large-size pores in heavy oil catalytic materials, but at present, the pore size distributions in the majority of catalytic cracking catalysts have difficulty reaching an ideal proportion of mesopores and micropores. Also, due to the restriction of reaction channels, intermediates and target products are cracked excessively and coke is thereby generated. The generation of coke in a large amount has a severe impact on the catalytic cracking reaction. First of all, the coke covers the active center of the catalyst, so the catalyst is quickly deactivated. Additionally, the enhanced coke yield increases the regeneration load of the catalytic cracking unit, so, for one thing, the strict regeneration at a higher temperature destroys the catalyst more seriously. Also, because of the restriction of heat balance of the unit, the throughput of the unit decreases. Finally, due to the generation of coke in a large amount, the yield of valuable target products decreases, obviously affecting the economic benefits of the unit. Decreasing the coke yield during the FCC process is one of the most concerned key problems in the oil refining industry.

In order to solve this problem, the adoption of technologies of catalysts that can decrease the coke yield becomes a key research direction for economic reasons, etc. Currently, the contents of research concerning decreasing coke yield mainly focuses on semi-synthetic catalysts, and achieves them by means of ultrastabilization of NaY zeolite and preparation of carriers with good acidity and pore distribution.

U.S. Pat. No. 4,085,069 discloses a technology of ammonium exchange of zeolite at superatmospheric pressures, at a high operation cost. U.S. Pat. No. 4,093,560 discloses a method for treating Y-zeolite with EDTA mainly by removing framework aluminum. U.S. Pat. No. 5,143,878 discloses a method for treating NaY zeolite with an organic acid to make its unit cell constant in the range of 2.423 to 2.433 nm. U.S. Pat. No. 5,534,135 discloses a method for treating an ultrastable Y-zeolite by contacting the hydrothermally-treated zeolite in an acid medium, and the resulting target product has a unit cell constant of less than 2.419 nm.

Chinese Pat. No. 200410096002.1 discloses a method for continuously preparing a rare earth ultrastable Y-zeolite, and the examples show that such zeolite contains much non-framework aluminum, thereby having adverse effects in decreasing coke. Chinese Pat. No. 87104086.7 provides a method of hydrothermal ultrastabilization, and part of the framework aluminum is removed. Chinese Pat. No. 200410029876.5 provides a method for preparing a rare earth ultrastable Y-zeolite using citric acid as an aluminum-removal agent. Chinese Pat. No. 02103909.7 discloses a method for preparing an ultrastable Y-zeolite using oxalic acid as an aluminum complexing agent.

In the existing patents, the NaY zeolite is principally treated by technologies like solid phase hydrothermal removal of aluminum, gas-solid phase chemical removal of aluminum, and liquid-solid phase chemical removal of aluminum to decrease the coke yield. However, in practical applications, there are problems such as heavy contamination, serious corrosion to equipment, severe destruction of zeolite caused by ultrastabilization, and decrease of conversion, etc.

U.S. Engelhard Corp. successfully developed a technology for preparing in-situ crystallized FCC catalysts from refined kaolin in the 1960's, and this technology is distinctively characterized in stable zeolite and abundant pore structure, thereby laying the foundations of the preparation of environmental friendly FCC catalysts with high conversion and low coke yield. U.S. Pat. No. 4,493,902 to Brown et al of Engelhard Corp. in 1985 disclosed a method for synthesizing a Y-faujasite zeolite by in-situ crystallization of kaolin microspheres, one key point of which was the necessity of adding seed crystal and ultrafine calcined kaolin to kaolin microspheres prior to forming so that the catalyst showed a good performance during the catalytic cracking reaction. Since then, Engelhard Corp. applied a series of patents around this process, e.g. U.S. Pat. No. 7,101,473; U.S. Pat. No. 6,943,132; U.S. Pat. No. 6,942,784; U.S. Pat. No. 6,716,338; U.S. Pat. No. 6,696,378; and Chinese Pat. No. 1179734A, etc. In 1993, Elena I. Bassadella et al. synthesized the Y-faujasite zeolite by in-situ crystallization of kaolinite microspheres using the same method, and clearly observed crystal grains having a size of 0.5 μm (Elenal. Bassadalla et al., Ind. Eng. Chem. Res. 1993, 32, 751). Since the crystal grains of Y-zeolite synthesized by the conventional gelation method have a size of around 0.8 μm, such in-situ crystallized zeolite with small crystal grains provides strong conditions for decreasing coke yield. However, this technology of Engelhard Corp. is disadvantaged in calcining kaolin twice, complicated process and high energy consumption.

Therefore, the Catalyst Plant of Lanzhou Petrochemical Company (Lanzhou, Gansu) adopted a technology of crystallizing a mixture of metakaolin microspheres (“metakaolin” for short) and spinel-containing kaolin microspheres (“kaolin” for short) and applied a series of patents for it, e.g. Chinese Pat. No. 1334314A, Chinese Pat. No. 1232862A, and Chinese Pat. No. 1334318A, etc., but verification experiments prove that the metakaolin microspheres obtained by this process have reduced strength so that the solid content of the catalytic cracking oil slurry rises. Furthermore, in the aspect of decreasing coke yield, Chinese Pat. No. 00122006.3 to the Catalyst Plant of Lanzhou Petrochemical Company disclosed a catalyst with a reduced coke yield, of which the preparing method still adopted the technology of mixing metakaolin microspheres with kaolin microspheres. Verification experiments prove that the post-treatment process still leads to a lot of non-framework aluminum existing in the catalyst, thereby causing adverse effects on the selective generation of coke. Also, because the zeolite content is in the range of 25% to 35%, the resulting activity of the unltrastable catalyst is difficult to meet the requirements in the fact that more and more crude oil used today is of the heavy type.

### SUMMARY OF THE INVENTION

An object of the present invention is to provide a fluid catalytic cracking (FCC) catalyst with a low coke yield and a method for making the same. The FCC catalyst product of the present invention with a low coke yield is produced using a new in-situ crystallization process, based on the technology of in-situ crystallization of kaolin, has a high Si to Al ratio, a high zeolite content, a low abrasion index, a high activity and a high coke selectivity.

The method for making a FCC catalyst with a low coke yield provided by the present invention is implemented using a new technology of in-situ crystallization and synthesis of kaolin and post-modification, includes: adding water to one portion of kaolin to form a slurry, followed by spray forming to obtain microspheres, calcining the microspheres to obtain spinel-containing calcined microspheres; calcining the other portion of kaolin to form metakaolin, which is subjected to ultrafine pulverization to obtain metakaolin ultrafine powder; mixing sodium silicate, sodium hydroxide, a directing agent, the calcined microspheres and the metakaolin ultrafine powder together in a certain proportion, crystallizing the resultant mixture at a certain temperature for some time, and subjecting the crystallized system to centrifugal separation to obtain a microspheroidal crystallized product containing an in-situ crystallized NaY zeolite; and subjecting said microspheroidal crystallized product to ion exchange and deep ultrastable hydrothermal treatment to finally obtain the FCC catalyst with a low coke yield of the present invention.

Specifically, the method for making a FCC catalyst with a low coke yield of the present invention includes the steps of:

a) forming a kaolin slurry having a solid content of 25-60% by mixing kaolin with water, adding a dispersant in a small amount thereinto, followed by mixing and spray drying to obtain kaolin microspheres;

b) calcining the kaolin microspheres obtained in step (a) at a temperature of 900 to 1100° C. for 1 to 3 hours to convert the microspheres into calcined microspheres mainly containing spinel, accompanied by a small amount of mullite, via phase transition;

c) calcining kaolin at a temperature of 600 to 850° C. for 1 to 3 hours to convert it into metakaolin, and subjecting said metakaolin to ultrafine pulverization to obtain metakaolin ultrafine powder;

d) mixing the calcined microspheres obtained in step (b) and the metakaolin ultrafine powder obtained in step (c) with sodium silicate, sodium hydroxide and a directing agent to obtain a mixture, subjecting said mixture to hydrothermal crystallization at 80 to 100° C. for 10 to 40 hours to obtain an in-situ crystallized product, and subjecting said crystallized product to centrifugal separation and water washing to obtain NaY zeolite-containing crystallized microspheres; and

e) subjecting the crystallized microspheres obtained in step (d) to ion exchange and modification by calcination to obtain the FCC catalyst with a low coke yield.

Wherein, in step (a), the kaolin may be soft kaolin, hard kaolinite rock or coal gangue, but it must comprise above 80% by weight kaolin crystal, less than 0.5% by weight quartz, less than 1.0% by weight Fe₂O₃, and less than 0.5% by weight K₂O and Na₂O in all; the dispersant is a conventional dispersant, such as sodium silicate, sodium pyrophosphate or sodium hexametaphosphate, used in an amount of 1-10% based on the weight of kaolin; more than 90% of the kaolin microspheres have a particle size of 30 to 100 μm;

in step (c), more than 95% of the metakaolin ultrafine powder has a particle size of less than 1 μm;

in step (d), the directing agent is composed of components in a ratio well known by those skilled in the art, namely, 15SiO₂:Al₂O₃:16Na₂O:320H₂O (in a molar ratio); the crystallized system comprises calcined microspheres, metakaolin ultrafine powder, sodium silicate and the directing agent at a mass ratio of 1:0.05-0.15:5-10:0.10-0.20, and the sodium content expressed as Na₂O and the silicon content expressed as SiO₂ in the directing-agent-free liquid-phase system of said mixture are in a Na₂O/SiO₂ molar ratio of 0.3-0.8; and

the in-situ crystallized microspheres obtained in step (d) have a zeolite crystallinity of 30-60% and a Si to Al molar ratio of 5.0-5.8.

The ion exchange and modification by calcination of the crystallized microspheres in step (e) include the steps of:

1) the first ion modification: introducing the crystallized microspheres obtained in step (d) and ammonium sulfate into water in a mass ratio of ammonium sulfate to crystallized microspheres of 0.2-0.5, followed by exchange at pH of 3.0 to 3.5 and a temperature of 90 to 94° C. for 0.5 to 1 hour, and subjecting the exchanged microspheres to filtration, water washing and another filtration to obtain a first ion modified material;

2) the second ion modification: introducing the first ion modified material obtained in step (1) and a mixed rare earth chloride into water in a mass ratio of RE₂O₃ to the first ion modified material of 0.02-0.04, followed by exchange at pH of 3.5 to 4.0 and a temperature of 90 to 94° C. for 0.5 to 1 hour, and subjecting the exchanged microspheres to filtration, water washing and another filtration to obtain a second ion modified material;

3) the first calcination: calcining the second ion modified material obtained in step (2) in an 100% steam atmosphere at 600 to 700° C. for 1 to 3 hours to obtain a first calcined material;

4) the third ion modification: introducing the first calcined material obtained in step (3) and ammonium sulfate into water in a mass ratio of ammonium sulfate to the first calcined material of 0.1-0.3, followed by exchange at pH of 3.0 to 3.5 and a temperature of 90 to 94° C. for 0.5 to 1 hour, and subjecting the exchanged microspheres to filtration, water washing and another filtration to obtain a third ion modified material;

5) the second calcination: calcining the third ion modified material obtained in step (4) in an 100% steam atmosphere at 600 to 700° C. for 1 to 3 hours to obtain a second calcined material; and

6) the fourth ion modification: introducing the second calcined material obtained in step (5) and citric acid into water in a mass ratio of citric acid to the second calcined material of 0.03-0.06, followed by exchange at pH of 3.0 to 3.5 and a temperature of 90 to 94° C. for 0.5 to 1 hour, filtration and drying to obtain the FCC catalyst with a low coke yield of the present invention.

The FCC catalyst with a low coke yield of the present invention has the following physical and chemical properties: a Na₂O content of not more than 0.4% by mass, a content of RE₂O₃ of 2-4% by mass, having a unit cell constant a₀ of 2.450-2.455 nm, having a microreactor activity (measured after aging in 100% steam at 800° C. for 17 hours) of not less than 68% by mass, and having an abrasion index of not more than 1.5% by mass.

In the method for making a FCC catalyst with a low coke yield using an in-situ crystallization technology in the present invention, the catalyst is completely prepared from the calcined microspheres, and metakaolin having a bad strength is not comprised in the catalyst but only acts as one of the aluminum source and silicon source during crystallization, so, not only the zeolite content of the catalyst is increased but also its strength is enhanced; in addition, by means of the technology of ion exchange and deep ultrastabilization of the present invention, the unit cell constant can be decreased effectively and the aluminum scraps outside the framework can be removed. Thus, the catalyst of the present invention has the advantages of high strength, high Si to Al ratio, high activity and high coke selectivity.

### DETAILED DESCRIPTION OF THE PREFERRED EMBODIMENTS

The main analytical testing methods used in the examples: the main analytical testing methods involved in the invention is described in “Analysis Method for Petrochemical Technology˜RIPP Standard” edited by Cuiding Yang et al and published by Science Press in 1990.

The main raw materials used in the examples:

Kaolin: industrial product, produced by Suzhou Kaolin Company (Suzhou, Jiangsu, China);

Soluble glass: industrial product, produced by Yuxi Meiyuan Soluble Glass Plant II (Yuxi, Yunnan, China), SiO₂ 302 g/L, Na₂O 74 g/L;

Sodium meta-aluminate: industrial product, produced by Zibo Zichuan Sanhong Chemical Factory (Zibo, Shandong, China), Al₂O₃ 64 g/L, Na₂O 265 g/L;

Sodium hydroxide: industrial product, produced by Zibo Linzi Chenmin Chemical Co., Ltd. (Zibo, Shandong, China), Na₂O 200 g/L;

Ammonium sulfate: industrial product, produced by Jiaocheng KNLAN Chemical CO., LTD. (Jiaocheng, Shanxi, China);

Mixed rare earth chloride solution: industrial product, produced by Baotou Guangyuan Chemical Co., Ltd. (Baotou, Neimenggu, China), RE₂O₃: 238 g/L;

Hydrochloric acid: industrial product, produced by Xuzhou JianPing Chemical Co., Ltd. (Xuzhou, Jiangsu, China), 37%.

The following examples further describe but don't limit the present invention.

### EXAMPLE 1

### Preparation of Kaolin Microspheres

10 kg of kaolin were mixed uniformly with chemical water and 3% (based on the mass of the kaolin) hexametaphosphate to form a kaolin slurry having a solid content of 32%. The kaolin slurry was subjected to spray forming in a spray granulation tower to produce kaolin microspheres, more than 90% of which had a particle size of 30 to 100 μm.

### EXAMPLE 2

### Preparation of Kaolin Microspheres

10 kg of kaolin were mixed uniformly with chemical water and 7% (based on the mass of the kaolin) soluble glass to form a kaolin slurry having a solid content of 50%. The kaolin slurry was subjected to spray forming in a spray granulation tower to produce kaolin microspheres, more than 90% of which had a particle size of 30 to 100 μm.

### EXAMPLE 3

### Preparation of Calcined Microspheres

3.0 kg of the kaolin microspheres obtained in Example 1 were calcined in a muffle furnace at 940° C. for 2.5 h to obtain calcined microspheres.

### EXAMPLE 4

### Preparation of Calcined Microspheres

2.5 kg of the kaolin microspheres obtained in Example 2 were calcined in a muffle furnace at 1040° C. for 1 h to obtain calcined microspheres.

### EXAMPLE 5

### Preparation of Metakaolin Ultrafine Powder

2.0 kg of kaolin was calcined in a muffle furnace at 640° C. for 2 h to obtain metakaolin. The metakaolin was subjected to ultrafine pulverization in an ultrafine grinder to produce ultrafine metakaolin powder, more than 95% of which had a particle size of less than 1 μm measured by a laser particle size analyzer.

### EXAMPLE 6

### Preparation of Metakaolin Ultrafine Powder

1.0 kg of kaolin was calcined in a muffle furnace at 820° C. for 1 h to obtain metakaolin. The metakaolin was subjected to ultrafine pulverization in an ultrafine grinder to produce ultrafine metakaolin powder, more than 95% of which had a particle size of less than 1 μm measured by a laser particle size analyzer.

### EXAMPLE 7

### Preparation of In-Situ Crystallized Product

2523 ml of soluble glass, 48 ml of a solution of sodium hydroxide, 37 g of a directing agent, 300 g of the calcined microspheres obtained in Example 3, and 25 g of the metakaolin ultrafine powder obtained in Example 5 were successively added into a crystallization reactor, heated to 85° C. under stirring and then crystallized for 36 h to obtain a in-situ crystallized product. The in-situ crystallized product was subjected to centrifugal separation and water washing to a pH of less than 11. The resultant crystallized product was measured to have a crystallization of 36% and an Si to Al ratio of 5.6.

### EXAMPLE 8

### Preparation of In-Situ Crystallized Product

3424 ml of soluble glass, 240 ml of a solution of sodium hydroxide, 90 g of a directing agent, 600 g of the calcined microspheres obtained in Example 3, and 40 g of the metakaolin ultrafine powder obtained in Example 6 were successively added into a crystallization reactor, heated to 90° C. under stirring and then crystallized for 24 h to obtain a in-situ crystallized product. The in-situ crystallized product was subjected to centrifugal separation and water washing to a pH of less than 11. The resultant crystallized product was measured to have a crystallization of 40% and a Si to Al ratio of 5.5.

### EXAMPLE 9

### Preparation of In-Situ Crystallized Product

7243 ml of soluble glass, 435 ml of a solution of sodium hydroxide, 80 g of a directing agent, 750 g of the calcined microspheres obtained in Example 4, and 73 g of the metakaolin ultrafine powder obtained in Example 5 were successively added into a crystallization reactor, heated to 92° C. under stirring and then crystallized for 20 h to obtain a in-situ crystallized product. The in-situ crystallized product was subjected to centrifugal separation and water washing until the pH was less than 11. The resultant crystallized product was measured to have a crystallization of 44% and an Si to Al ratio of 5.3.

### EXAMPLE 10

### Preparation of In-Situ Crystallized Product

2260 ml of soluble glass, 253 ml of a solution of sodium hydroxide, 65 g of a directing agent, 400 g of the calcined microspheres obtained in Example 4, and 55 g of the metakaolin ultrafine powder obtained in Example 6 were successively added into a crystallization reactor, heated to 96° C. under stirring and then crystallized for 14 h to obtain a in-situ crystallized product. The in-situ crystallized product was subjected to centrifugal separation and water washing until the pH was less than 11. The resultant crystallized product was measured to have a crystallization of 54% and a Si to Al ratio of 5.1.

### EXAMPLE 11

### Preparation of Catalyst With Low Coke Yield

200 g of the crystallized product obtained in Example 7 and 50 g of ammonium sulfate were added into 200 mL of chemical water in an exchange reactor. Then, hydrochloric acid was added in to adjust the pH to 3.2, and the crystallized product was exchanged at 91° C. for 0.5 h. The exchanged microspheres were subjected to filtration, water washing and another filtration to obtain a first ion modified product. The first ion modified product and 32 ml of a mixed rare earth chloride solution was added into 2000 mL of chemical water. Then, hydrochloric acid was added in to adjust the pH to 3.7, and the first ion modified product was exchanged with the mixed rare earth chloride at 90° C. for 0.8 h. The exchanged microspheres were subjected to filtration, water washing and another filtration to obtain a second ion modified material. The second ion modified material was calcined in a 100% steam atmosphere at 630° C. for 2.0 h to obtain a first calcined material. The first calcined material and 20 g of ammonium sulfate were added into 200 mL of chemical water. Then, hydrochloric acid was added in to adjust the pH to 3.4, and the first calcined material was exchanged with ammonium sulfate at 90° C. for 1 h. The exchanged microspheres were subjected to filtration, water washing and another filtration to obtain a third ion modified material. The third ion modified material was calcined in a 100% steam atmosphere at 650° C. for 1.0 h to obtain a second calcined material. The second calcined material and 7 g of citric acid were added into 520 mL of chemical water and exchanged at pH 3.3 at 92° C. for 1 hour, and then subjected to water washing, filtration and drying to obtain an FCC catalyst with a reduced coke yield of the invention, which was numbered as ES-11.

### EXAMPLE 12

### Preparation of Catalyst With Low Coke Yield

400 g of the crystallized product obtained in Example 8 and 160 g of ammonium sulfate were added into 3800 mL of chemical water placed in an exchange reactor. Then, hydrochloric acid was added in to adjust the pH to 3.2, and the crystallized product was exchanged at 91° C. for 0.8 h. The exchanged microspheres were subjected to filtration, water washing and another filtration to obtain a first ion modified product. The first ion modified product and 48 ml of a mixed rare earth chloride solution were added into 3800 mL of chemical water. Then hydrochloric acid was added in to adjust the pH to 3.6, and the first ion modified product was exchanged at 90° C. for 1.0 h. The exchanged microspheres were subjected to filtration, water washing and another filtration to obtain a second ion modified material. The second ion modified material was calcined in a 100% steam atmosphere at 660° C. for 1.5 h to obtain a first calcined material. The first calcined material and 22 g of ammonium sulfate were added into 2500 mL of chemical water, then hydrochloric acid was added in to adjust the pH to 3.4, and the first calcined material was exchanged at 90° C. for 1 h. The exchanged microspheres were subjected to filtration, water washing and another filtration to obtain a third ion modified material. The third ion modified material was calcined in a 100% steam atmosphere at 680° C. for 1.0 h to obtain a second calcined material. The second calcined material was added into 1500 mL of chemical water with 13 g of citric acid and exchanged at pH3.2 and 92° C. for 1 h, and then subjected to water washing, filtration and drying to obtain an FCC catalyst with a reduced coke yield of the invention, which was numbered as ES-12.

### EXAMPLE 13

### Preparation of Catalyst With Low Coke Yield

500 g of the crystallized product obtained in Example 9 and 200 g of ammonium sulfate were added into 3300 mL of chemical water in an exchange reactor, then hydrochloric acid was added in to adjust the pH to 3.4, and the crystallized product was exchanged at 90° C. for 1.0 h. The exchanged microspheres were subjected to filtration, water washing and another filtration to obtain a first ion modified product. The first ion modified product and 45 ml of a mixed rare earth chloride solution was added into 3300 mL of chemical water, then hydrochloric acid was added in to adjust the pH to 3.8, and the first ion modified product was exchanged at 92° C. for 1.0 h. The exchanged microspheres were subjected to filtration, water washing and another filtration to obtain a second ion modified material. The second ion modified material was calcined in a 100% steam atmosphere at 620° C. for 1.5 h to obtain a first calcined material. The first calcined material and 100 g of ammonium sulfate were added into 2000 mL of chemical water, then hydrochloric acid was added in to adjust the pH to 3.4, and the first calcined material was exchanged at 90° C. for 1 h. The exchanged microspheres were subjected to filtration, water washing and another filtration to obtain a third ion modified material. The third ion modified material was calcined in a 100% steam atmosphere at 680° C. for 1.0 h to obtain a second calcined material. The second calcined material was added into 1800 mL of chemical water with 25 g of citric acid and exchanged at pH 3.4 and 90° C. for 1 h, and then subjected to water washing, filtration and drying to obtain an FCC catalyst with a reduced coke yield of the invention, which was numbered as ES-13.

### EXAMPLE 14

### Preparation of Catalyst With Low Coke Yield

200 g of the crystallized product obtained in Example 10 and 65 g of ammonium sulfate were added into 2200 mL of chemical water in an exchange reactor, then hydrochloric acid was added in to adjust the pH to 3.1, and the crystallized product was exchanged at 90° C. for 1.0 h. The exchanged microspheres were subjected to filtration, water washing and another filtration to obtain a first ion modified product. The first ion modified product and 25 ml of a mixed rare earth chloride solution were added into 2200 mL of chemical water, then hydrochloric acid was added in to adjust the pH to 3.7, and the first ion modified product was exchanged at 90° C. for 1.0 h. The exchanged microspheres were subjected to filtration, water washing and another filtration to obtain a second ion modified material. The second ion modified material was calcined in a 100% steam atmosphere at 680° C. for 1.5 h to obtain a first calcined material. The first calcined material and 41 g of ammonium sulfate were added into 1000 mL of chemical water, then hydrochloric acid was added in to adjust the pH to 3.2, and the first calcined material was exchanged at 90° C. for 1 h. The exchanged microspheres were subjected to filtration, water washing and another filtration to obtain a third ion modified material. The third ion modified material was calcined in a 100% steam atmosphere at 680° C. for 1.0 h to obtain a second calcined material. The second calcined material was added into 1400 mL of chemical water with 9 g of citric acid, and exchanged at pH 3.4 and 90° C. for 1 h, and then subjected to water washing, filtration and drying to obtain an FCC catalyst with a reduced coke yield of the invention, which was numbered as ES-14.

### EXAMPLE 15

### Tests of Physical and Chemical Properties and Catalytic Performances of Catalysts With Low Coke Yield of the Present Invention

The physical and chemical properties and catalytic performances of the catalysts obtained in Examples 11 to 14 were measured separately, and were compared with those of the catalysts as industrial products. The results are shown in Table 1 and Table 2.

TABLE 1
Physical and Chemical Properties of Catalysts

| | Number | | | | Industrial |
|---|---|---|---|---|---|
| | ES-11 | ES-12 | ES-13 | ES-14 | Catalyst |
| Na₂O, % | 0.24 | 0.32 | 0.34 | 0.36 | 0.30 |
| RE₂O₃, % | 3.5 | 1.7 | 2.3 | 2.8 | 3.4 |
| A₀, ×10^{~9} | 2.454 | 2.451 | 2.453 | 2.451 | 2.458 |
| Abrasion | 1.1 | 1.2 | 1.1 | 1.0 | 2.9 |
| Index, m % | | | | | |
| Microreactor | 69 | 70 | 71 | 72 | 63 |
| Activity, m % | | | | | |

TABLE 2
Catalytic Performances of Catalysts

| | | | Industrial |
|---|---|---|---|
| Catalyst | ES-12 | ES-13 | Catalyst |
| Dry Gas, m % | 1.21 | 1.35 | 1.41 |
| Liquified Gas, | 23.54 | 23.75 | 23.32 |
| m % | | | |
| Gasoline, m % | 40.47 | 39.67 | 38.44 |
| Diesel Oil, m % | 15.56 | 16.43 | 14.31 |
| Oil Slurry, m % | 11.45 | 10.63 | 13.33 |
| Coke, m % | 7.89 | 8.21 | 9.24 |
| Conversion, m % | 73.11 | 72.98 | 72.41 |
| Liquid Yield, | 79.57 | 79.85 | 76.07 |
| m % | | | |
| Yield of Light | 56.03 | 56.1 | 52.75 |
| Oil, m % | | | |
| Coke/Liquid | 0.099 | 0.103 | 0.121 |
| Yield | | | |

As shown in Table 1, compared with industrial products, the catalysts prepared in the present invention had excellent abrasion resistance and activity stability, wherein the microreactor activities were measured after the aging of samples in 100% steam at 800° C. for 17 hours.

As shown in Table 2, compared with industrial products, the catalysts prepared in the present invention not only had an obviously improved coke selectivity (Coke/Liquid Yield), but also had a remarkably decreased coke yield on the premise of obviously increased liquid yield (liquified gas+gasoline+diesel oil) and yield of light oil (gasoline+diesel oil). The evaluation was carried out on a fixed fluidized bed after the aging of samples in 100% steam at 800° C. for 10 hours, and the raw oil used in the invention was the catalytic cracking feedstock from Changling Smelting Corp. (Yueyang, Hunan, China).

1. A fluid catalytic cracking catalyst with a low coke yield made by the method comprising:
a) making a kaolin slurry having solid content of 25-60% from kaolin and chemical water, adding a dispersant thereinto, followed by mixing and spray drying to obtain kaolin microspheres;
b) calcining the kaolin microspheres obtained in step (a) at a temperature of 900 to 1100° C. for 1 to 3 hours to obtain calcined microspheres;
c) calcining kaolin at a temperature of 600 to 850° C. for 1 to 3 hours to obtain metakaolin, and subjecting said metakaolin to ultrafine pulverization to obtain metakaolin ultrafine powder;
d) mixing the calcined microspheres obtained in step (b) and the metakaolin ultrafine powder obtained in step (c) with sodium silicate, sodium hydroxide and a directing agent to obtain a mixture, subjecting said mixture to hydrothermal crystallization at a temperature of 80 to 100° C. for 10 to 40 hours to obtain an in-situ crystallized product, and subjecting said crystallized product to centrifugal separation and water washing to obtain NaY zeolite-containing crystallized microspheres, wherein said mixture comprises calcined microspheres, metakaolin ultrafine powder, sodium silicate and the directing agent at a mass ratio of 1:0.05-0.15:5-10:0.10-0.20, and the sodium content expressed as Na₂O and the silicon content expressed as SiO₂ in the directing-agent-free liquid-phase system of said mixture are in a Na₂O/SiO₂ molar ratio of 0.3-0.8; and
e) subjecting the zeolite NaY-containing crystallized microspheres obtained in step (d) to ion exchange and modification by calcination to obtain the fluid catalytic cracking catalyst.

2. The fluid catalytic cracking catalyst of claim 1, wherein said kaolin is selected from the group consisting of soft kaolin, hard kaolinite rock and coal gangue, and comprises above 80% by weight kaolin crystal, less than 0.5% by weight quartz, less than 1.0% by weight Fe₂O₃, and less than 0.5% by weight K₂O and Na₂O in all.

3. The fluid catalytic cracking catalyst of claim 1, wherein said dispersant is selected from the group consisting of sodium silicate, sodium pyrophosphate and sodium hexametaphosphate, in an amount of 1-10% based on the weight of kaolin.

4. The fluid catalytic cracking catalyst of claim 1, wherein the components of said directing agent are in a molar ratio of 15SiO₂:Al₂O₃:16Na₂O:320H₂O.

5. The fluid catalytic cracking catalyst of claim 1, wherein the in-situ crystallized product obtained in step (d) has a crystallinity of 30-60% and a silicon to aluminum molar ratio of 4.0-5.8.

6. The fluid catalytic cracking catalyst of claim 1, wherein said fluid catalytic cracking catalyst has the following physical and chemical properties:
a Na₂O content of not higher than 0.4% by mass, a RE₂O₃ content of 2-4% by mass, unit cell constant a₀ of 2.450-2.455 nm, microreactor activity of not less than 68% by mass measured after aging in 100% steam at 800° C. for 17 hours, and an abrasion index of not more than 1.5% by mass.

7. A method for making a fluid catalytic cracking catalyst comprising the steps of:
a) making a kaolin slurry having solid content of 25-60% from kaolin and chemical water, adding a dispersant thereinto, followed by mixing and spray drying to obtain kaolin microspheres;
b) calcining the kaolin microspheres obtained in step (a) at a temperature of 900 to 1100° C. for 1 to 3 hours to obtain calcined microspheres;
c) calcining kaolin at a temperature of 600 to 850° C. for 1 to 3 hours to obtain metakaolin, and subjecting said metakaolin to ultrafine pulverization to obtain metakaolin ultrafine powder;
d) mixing the calcined microspheres obtained in step (b) and the metakaolin ultrafine powder obtained in step (c) with sodium silicate, sodium hydroxide and a directing agent to obtain a mixture, subjecting said mixture to hydrothermal crystallization at a temperature of 80 to 100° C. for 10 to 40 hours to obtain an in-situ crystallized product, and subjecting said crystallized product to centrifugal separation and water washing to obtain NaY zeolite-containing crystallized microspheres, wherein said mixture comprises calcined microspheres, metakaolin ultrafine powder, sodium silicate and the directing agent at a mass ratio of 1:0.05-0.15:5-10:0.10-0.20, and the sodium content expressed as Na₂O and the silicon content expressed as SiO₂ in the directing-agent-free liquid-phase system of said mixture are in a Na₂O/SiO₂ molar ratio of 0.3-0.8; and
e) subjecting the NaY zeolite-containing crystallized microspheres obtained in step (d) to ion exchange and modification by calcination to obtain the fluid catalytic cracking catalyst.

8. The method of claim 7, wherein the ion exchange and modification by calcinations in step (e) comprise the steps of:
1) the first ion modification: introducing the crystallized microspheres obtained in step (d) and ammonium sulfate into water in a mass ratio of ammonium sulfate to crystallized microspheres of 0.2-0.5, followed by exchange at pH of 3.0 to 3.5 and a temperature of 90 to 94° C. for 0.5 to 1 hour to obtain a first ion modified material;
2) the second ion modification: introducing the first ion modified material obtained in step (1) and a mixed rare earth chloride into water in a mass ratio of RE₂O₃ to the first ion modified material of 0.02-0.04, followed by exchange at pH of 3.5 to 4.0 and a temperature of 90 to 94° C. for 0.5 to 1 hour to obtain a second ion modified material;
3) calcining the second ion modified material obtained in step (2) in an 100% steam atmosphere at 600 to 700° C. for 1 to 3 hours to obtain a first calcined material;
4) introducing the first calcined material obtained in step (3) and ammonium sulfate into water in a mass ratio of ammonium sulfate to the first calcined material of 0.1-0.3, followed by exchange at pH of 3.0 to 3.5 and a temperature of 90 to 94° C. for 0.5 to 1 hour to obtain a third ion modified material;
5) calcining the third ion modified material obtained in step (4) at 600 to 700° C. in an 100% steam atmosphere for 1 to 3 hours to obtain a second calcined material; and
6) introducing the second calcined material obtained in step (5) and citric acid into water in a mass ratio of citric acid to the second calcined material of 0.03-0.06, followed by exchange at pH of 3.0 to 3.5 and a temperature of 90 to 94° C. for 0.5 to 1 hour, filtration and drying to obtain the fluid catalytic cracking catalyst.

9. The method of claim 7, wherein said dispersant is selected from the group consisting of sodium silicate, sodium pyrophosphate and sodium hexametaphosphate, in an amount of 1-10% based on the weight of kaolin.

10. The method of claim 9, wherein the components of said directing agent are in a molar ratio of 15SiO₂:Al₂O₃:16Na₂O:320H₂O.
